(19) United States
(12) Patent Application Publication
(10) Pub. No.: US 2007/0097704 A1
(43) Pub. Date: May 3, 2007

(54) Touch-controlled backlight module

(76) Inventor: Hsien-Chung Chou, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/315,490

(22) Filed: Dec. 23, 2005

(30) Foreign Application Priority Data
Nov. 2, 2005 (TW) 094218940

(51) Int. Cl. F21V 7/04; G09G 5/00

(52) U.S. Cl. 362/607; 362/602; 362/633; 345/176

(57) ABSTRACT

A touch-controlled backlight module including: a light guide board; at least one light-emitting unit for projecting light to an incident surface of the light guide board; and a reflective board positioned on rear side of the light guide board for reflecting the light coming from the light guide board back to the light guide board. A tablet module is laid on rear side of the reflective board. When released from a factory, the tablet module, the light guide board, the light-emitting unit and the reflective board are assembled to form a complete module. The tablet module is responsive of a signal of a nearby electronic pen to output a corresponding signal.

### BACKGROUND OF THE INVENTION

1. Field of the Invention

The present invention is related to a touch-controlled backlight module, and more particularly to a touch-controlled backlight module in which a tablet module is arranged for responding to a signal of a nearby electronic pen to output a corresponding signal.

2. Description of the Prior Art

The existent liquid crystal module includes a glass layer of an LCD and a backlight module arranged on rear side of the glass layer. The backlight module includes a light guide board, a light-emitting unit, a reflective board and a scattering board. The light emitted from the light-emitting unit passes through the light guide board to be uniformly outward scattered by the scattering board to rear side of the glass layer of the LCD. After assembled, the liquid crystal module is installable in the housing of a panel as one piece to form a liquid crystal panel.

The above liquid crystal module simply serves to show images. A user is unable to directly use an electronic pen to touch the glass layer of the LCD and achieve necessary functions. To improve this, some manufacturers remove the circuit board from rear side of the liquid crystal module and add a tablet module to the rear side of the liquid crystal module. Some other manufacturers remove the backlight module and add a tablet module to the liquid crystal module to achieve touch-controlled functions. Accordingly, the liquid crystal module is responsive of the signal of an electronic pen to emit a corresponding signal.

However, such assembly has some shortcomings as follows:

1. The backlight module has been tested. After the backlight module is re-disassembled and reassembled, the backlight module may be displaced from its true position. Also, the circuit may be opened to lead to defective product. Therefore, the ratio of good products can be hardly enhanced and the manufacturing cost is increased.

2. The liquid crystal module may be produced by a different manufacturer. Under such circumstance, the tests and rectifications of the liquid crystal module and the tablet module are not unified. As a result, when the tablet module is added to the back face of the liquid crystal module, the tablet module is subject to electromagnetic interference of the liquid crystal module. Therefore, when an electronic pen gets close to the liquid crystal module, the tablet module can hardly truly respond to the signal of the electronic pen. This greatly increases the possibility of misjudging the signal and lowers the quality of the product.

### SUMMARY OF THE INVENTION

It is therefore a primary object of the present invention to provide a touch-controlled backlight module including: a light guide board; at least one light-emitting unit for projecting light to an incident surface of the light guide board; and a reflective board positioned on rear side of the light guide board for reflecting the light coming from the light guide board back to the light guide board. A tablet module is laid on rear side of the reflective board. When released from a factory, the tablet module, the light guide board, the light-emitting unit and the reflective board are assembled to form a complete module. The tablet module is responsive of a signal of a nearby electronic pen to output a corresponding signal without affecting the original display function.

A scattering board is disposed on outer side of the front surface of the light guide board for uniformly scattering the light coming from the light guide board. At least one brightening board is disposed on outer side of the scattering boards for enhancing the light signal. Another scattering board is further overlaid on outer side of the outermost brightening board for uniformly outward scattering the light coming from the outermost brightening board.

It is a further object of the present invention to provide a touch-controlled backlight module including: a light guide board; a light-emitting unit for projecting light to an incident surface of the light guide board; a reflective board positioned on rear side of the light guide board for reflecting the light coming from the light guide board back to the light guide board; and a glass layer of an LCD. The glass layer is arranged on outer side of the light guide board. A tablet module is laid on rear side of the reflective board. When released from a factory, the tablet module, the light guide board, the light-emitting unit, the reflective board and the glass layer of the LCD are assembled to form a complete module, whereby the tablet module is responsive of a signal of a nearby electronic pen to output a corresponding signal. The light guide board, the light-emitting unit, the reflective board, the glass layer of the LCD and the tablet module are assembled to form a touch-controlled liquid crystal module.

It is still a further object of the present invention to provide the above touch-controlled backlight module which can be installed on rear side of the glass layer of the LCD. The light emitted from the light source passes through the light guide board to be scattered by the outermost scattering board to the glass layer of the LCD. When an electronic pen gets close to or touches the glass layer of the LCD, the tablet module is triggered to emit a corresponding signal.

The present invention can be best understood through the following description and accompanying drawings wherein:

### BRIEF DESCRIPTION OF THE DRAWINGS

FIG. 1 is a perspective view of the present invention;

FIG. 2 is a side view of the present invention;

FIG. 3 is a side view of the complete touch-controlled backlight module of the present invention;

FIG. 4 is a side view of the touch-controlled backlight module of the present invention, in which the glass layer of the LCD is included; and

FIG. 5 is a side view of the touch-controlled backlight module of the present invention, which is installed on rear side of the glass layer of the LCD.

### DETAILED DESCRIPTION OF THE PREFERRED EMBODIMENTS

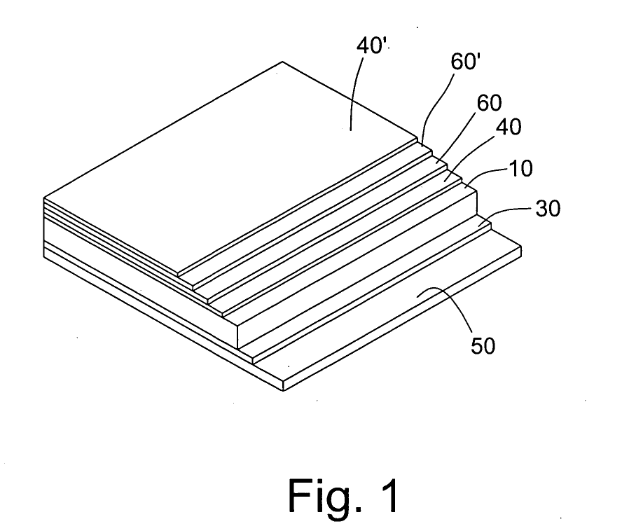

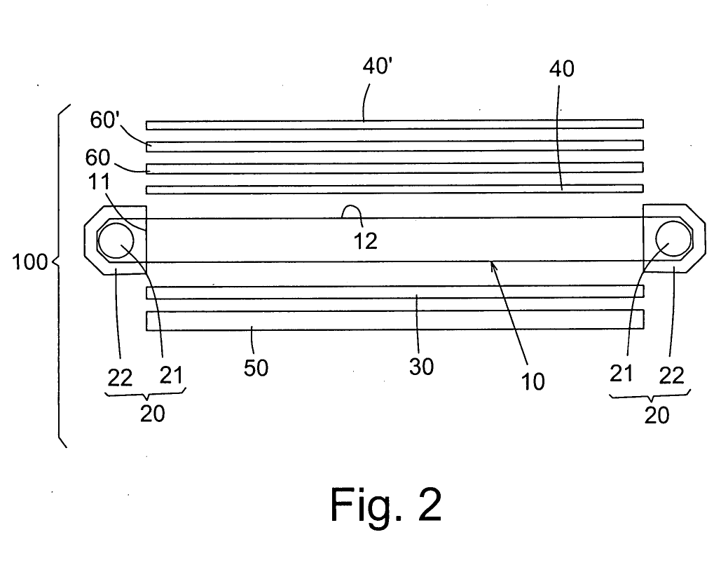

Please refer to FIGS. 1 to 5. The touch-controlled backlight module 100 of the present invention includes a light guide board 10, at least one light-emitting unit 20 for projecting light to the incident surface 11 of the light guide board 10 and a reflective board 30 positioned on rear side of the light guide board 10 for reflecting the light coming from the light guide board 10 back to the light guide board 10. A tablet module 50 is laid on rear side of the reflective board 30. When released from the factory, the tablet module 50, the light guide board 10, the light-emitting unit 20 and the reflective board 30 are assembled to form a complete module. The module is responsive of the signal of a nearby electronic pen to output a corresponding signal without affecting the original display function.

The touch-controlled backlight module 100 of the present invention further includes a scattering board 40 disposed on outer side of the front surface 12 of the light guide board 10 for uniformly scattering the light coming from the light guide board 10.

The light-emitting unit 20 of the touch-controlled backlight module 100 includes a light-emitting cell 21 such as cold cathode fluorescent lamp (CCFL) and a reflective shade 22. The light-emitting cell 21 is arranged on one side of the light guide board 10, facing the incident surface 11 thereof. The reflective shade 22 is arranged on one side of the light-emitting cell 21 for focusing the light emitted from the light-emitting cell 21 onto the light guide board 10. The light-emitting unit 20 pertains to prior art and will not be further described hereinafter. Any other conventional light-emitting unit is also applicable to the present invention.

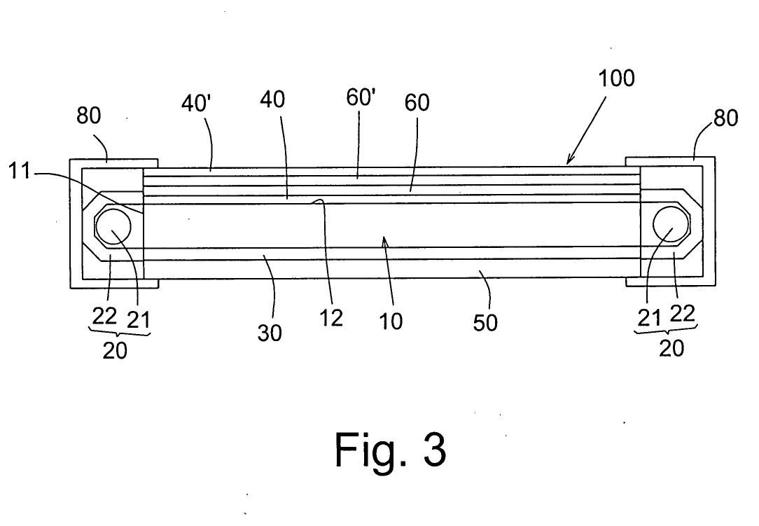

Referring to FIG. 3, the touch-controlled backlight module 100 of the present invention further includes a frame body 80 for enclosing and fixing the light guide board 10, the light-emitting unit 20, the reflective board 30, the scattering boards 40, 40′, the tablet module 50 and brightening boards 60, 60′ to form a firm and complete touch-controlled backlight module 100.

The touch-controlled backlight module 100 of the present invention further includes at least one brightening board 60, 60′ disposed on outer side of the scattering boards 40 for enhancing the light signal. Another scattering board 40′ is further overlaid on outer side of the outermost brightening board 60′ for uniformly outward scattering the light coming from the outermost brightening board 60′ as the glass layer 70 of a liquid crystal display (LCD).

In the touch-controlled backlight module 100 of the present invention, the scattering boards 40, 40′ and the brightening boards 60, 60′ can be omitted. Alternatively, only one or more scattering board 40, 40′ are disposed on the front surface 12 of the light guide board 10. Alternatively, only one or more brightening board 60, 60′ are disposed on the front surface 12 of the light guide board 10. Alternatively, a scattering board 40 and at least one brightening board 60 are dispose on the front surface 12 of the light guide board 10. Still alternatively, a brightening board 60 and at least one scattering board 40 are dispose on the front surface 12 of the light guide board 10. The combination and permutation as well as the position and number of the scattering boards 40, 40′ and the brightening boards 60, 60′ are not limited.

The touch-controlled backlight module 100 of the present invention includes the light guide board 10, the light-emitting unit 20, the reflective board 30 and the tablet module 50 mounted on rear side of the reflective board 30. The module 100 can be installed on rear side of the glass layer 70 of the LCD. When released from the factory, the light guide board 10, the light-emitting unit 20, the reflective board 30, the tablet module 50 and the glass layer 70 of the LCD are assembled to form a complete module. The module is responsive of the signal of a nearby electronic pen to output a corresponding signal. The light guide board 10, the light-emitting unit 20, the reflective board 30, the glass layer 70 of the LCD and the tablet module 50 are assembled to form a touch-controlled liquid crystal module (LCM). The touch-controlled backlight module 100 of the present invention is installed on rear side of the glass layer 70 of the LCD. The light emitted from the light source passes through the light guide board 10 to be scattered by the outermost scattering board 40′ to the glass layer 70 of the LCD. When a corresponding electronic pen (not shown) gets close to or touches the glass layer 70, the tablet module 50 is triggered to emit a signal. The touch-controlled liquid crystal module is applicable to liquid crystal display, liquid crystal handwriting board, write-read board, etc.

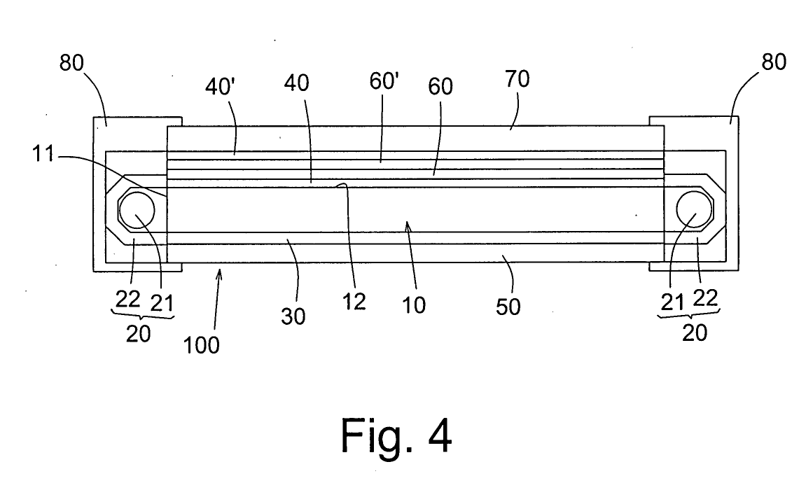

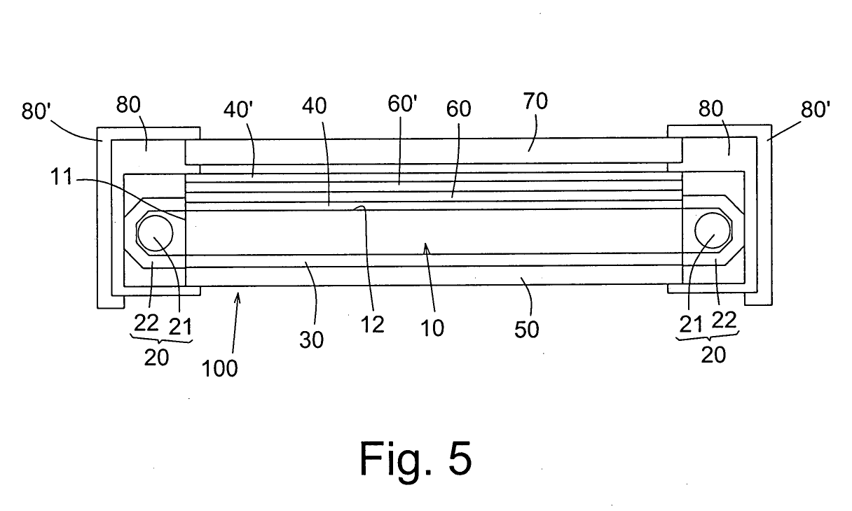

Referring to FIG. 4, the glass layer 70 of the LCD can be also enclosed in the frame body 80 of the touch-controlled backlight module 100 when assembled. Alternatively, as shown in FIG. 5, the glass layer 70 of the LCD is simply fixed on outer side of the touch-controlled backlight module 100 and an outer frame 80′ is further used to tightly bind the glass layer 70 of the LCD with the touch-controlled backlight module 100. Accordingly, when the touch-controlled backlight module 100 with or without the glass layer 70 of the LCD is sent to a downstream LCM assembling procedure, the touch-controlled backlight module 100 will not be re-disassembled. Therefore, the possibility of human damage to the touch-controlled backlight module 100 is minimized. Moreover, the components of the touch-controlled backlight module 100, such as the light-emitting unit 20, the light guide board 10, the reflective board 30 and the glass layer 70 of the LCD have been rectified to obviate any possible interference and error. Therefore, the tablet module 50 of the touch-controlled backlight module 100 can more truly respond to the electronic pen to emit the signal. Accordingly, the ratio of good products is enhanced.

The above embodiments are only used to illustrate the present invention, not intended to limit the scope thereof. Many modifications of the above embodiments can be made without departing from the spirit of the present invention.

What is claimed is:

1. A touch-controlled backlight module comprising:
(a) a light guide board;
(b) at least one light-emitting unit for projecting light to an incident surface of the light guide board; and
(c) a reflective board positioned on rear side of the light guide board for reflecting the light coming from the light guide board back to the light guide board, said touch-controlled backlight module being characterized in that a tablet module is laid on rear side of the reflective board, when released from a factory, the tablet module, the light guide board, the light-emitting unit and the reflective board are assembled to form a complete module, whereby the tablet module is responsive of a signal of a nearby electronic pen to output a corresponding signal.

2. The touch-controlled backlight module as claimed in claim 1, wherein at least one scattering board is disposed on outer side of a front surface of the light guide board.

3. The touch-controlled backlight module as claimed in claim 1 or 2, wherein at least one brightening board is disposed on outer side of the front surface of the light guide board.

4. The touch-controlled backlight module as claimed in claim 1, further comprising a frame body for enclosing and fixing the respective components of the touch-controlled backlight module to form a complete touch-controlled backlight module.

5. The touch-controlled backlight module as claimed in claim 1, further comprising a frame body for enclosing and fixing the respective components of the touch-controlled backlight module, the touch-controlled backlight module being positioned on rear side of a glass layer of an LCD, the touch-controlled backlight module and the glass layer of the LCD being bound with each other by an outer frame.

6. A touch-controlled backlight module comprising:
(a) a light guide board;
(b) at least one light-emitting unit for projecting light to an incident surface of the light guide board;
(c) a reflective board positioned on rear side of the light guide board for reflecting the light coming from the light guide board back to the light guide board; and
(d) a glass layer of an LCD, the glass layer being arranged on outer side of the light guide board, said touch-controlled backlight module being characterized in that a tablet module is laid on rear side of the reflective board, when released from a factory, the tablet module, the light guide board, the light-emitting unit, the reflective board and the glass layer of the LCD are assembled to form a complete module, whereby the tablet module is responsive of a signal of a nearby electronic pen to output a corresponding signal, the light guide board, the light-emitting unit, the reflective board, the glass layer of the LCD and the tablet module being assembled to form a touch-controlled liquid crystal module.

7. The touch-controlled backlight module as claimed in claim 6, wherein at least one scattering board is disposed between the light guide board and the glass layer of the LCD.

8. The touch-controlled backlight module as claimed in claim 6 or 7, wherein at least one brightening board is disposed between the light guide board and the glass layer of the LCD.

9. The touch-controlled backlight module as claimed in claim 6, further comprising a frame body for enclosing and fixing the respective components of the touch-controlled backlight module to form a complete touch-controlled backlight module.
